(19) United States
(12) Patent Application Publication
(10) Pub. No.: US 2026/0220109 A1
(43) Pub. Date: Jul. 30, 2026

(54) METHOD AND SYSTEM FOR PUBLISHING A VARIANCE DATA TO A TARGET SYSTEM

(71) Applicant: JPMorgan Chase Bank, N.A., New York, NY (US)

(72) Inventors: Amit GOYAL, Navi Mumbai (IN); Saurav SUMAN, Virar (IN); Adesh PATHAK, Mumbai (IN); Syed S ALI, Dewas (IN)

(73) Assignee: JPMorgan Chase Bank, N.A., New York, NY (US)

(21) Appl. No.: 19/086,939

(22) Filed: Mar. 21, 2025

(30) Foreign Application Priority Data
Jan. 30, 2025 (IN) 202511007813

(51) Int. Cl. G06F 16/22; G06F 16/2458; G06Q 30/01

(52) U.S. Cl. CPC G06F 16/22; G06F 16/2458; G06Q 30/01

(57) ABSTRACT

A method and system for publishing a variance data to a target system are disclosed. The method includes receiving a first set of data from a user. The method includes configuring a metadata for the first set of data. Further, the method includes loading the first set of data and the configured metadata into a first repository. Further, the method includes retrieving a second set of data from a second repository. Further, the method includes comparing the first set of data with the second set of data to identify the variance data. Further, the method includes loading the variance data with a predefined label into the second repository. Thereafter, the method includes publishing the variance data to the target system by utilizing the configured metadata.

### CROSS-REFERENCE TO RELATED APPLICATIONS

This application claims priority benefit from Indian Application No. 202511007813, filed on Jan. 30, 2025 in the India Patent Office, which is hereby incorporated by reference in its entirety.

### FIELD OF THE DISCLOSURE

This technology generally relates to a customer relationship management (CRM) system and integration, and more particularly relates to methods and systems for publishing a variance data to a target system.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With advancements in technology, various business sectors and organizations are accelerating their operations through the utilization of various tools and software for increasing the interactions with their customers. Nowadays, customer relationship management (CRM) software is a popular solution used for managing customer interactions, enhancing customer services and sales operations. The CRM software may facilitate various operational activities and usages such as merchant registration application, hosting merchant hierarchy, contact information, reporting needs, fee schedules and funds transfer instructions information. The CRM software may support different internal integration points within the organization and external integration points external to the organization.

During the development and integration of new features in the CRM software, a series of processes and numerous sequential tasks are required to perform, such as writing code, preparing documentation, and reviewing changes. The complexity and volume of such processes may significantly increase the time required to launch any new feature(s) to the market. The problem is further increased when larger data sets need to be handled to perform updates in the CRM software. Currently, sequential operational procedures are used to manage the data, thereby leading to delays in updating the CRM software, occurrence of errors (such as misalignment) in handling parent-child data relationships, and other related issues. Thus, inefficient handling of these data sets impacts development, integration responsiveness, and the overall scalability of the software.

In light of these and other existing limitations, there is an urgent need for an efficient solution that addresses the aforementioned challenges by providing a method and system capable of publishing variance data (e.g., any feature update) to a target system while eliminating the need for extensive sequential operational processes.

### SUMMARY

The present disclosure, through one or more of its various aspects, embodiments, and/or specific features or sub-components, provides, inter alias, various systems, servers, devices, methods, media, programs, and platforms for publishing a variance data to a target system.

According to an aspect of the present disclosure, a method for publishing a variance of data to a target system is disclosed. The method is implemented by at least one processor. The method may include receiving, by the at least one processor, a first set of data, from a user. Next, the method may include configuring, by the at least one processor, a metadata for the first set of data. Next, the method may include loading, by the at least one processor, the first set of data and the configured metadata into a first repository. Next, the method may include retrieving, by the at least one processor, a second set of data from a second repository. Next, the method may include comparing, by the at least one processor, the first set of data with the second set of data to identify the variance data. Next, the method may include loading, by the at least one processor, the variance data with a predefined label into the second repository. Thereafter, the method may include publishing, by the at least one processor, the variance data to the target system by utilizing the configured metadata.

In accordance with an exemplary embodiment, the first set of data may include at least one from among a message function name and a detailed description of the message function name.

In accordance with an exemplary embodiment, the configured metadata may have been configured for the first set of data by using at least one from among a data source name, a data source uniform resource locator (URL), a data source structured query language (SQL) query, a data structure configuration, a data hierarchy relationship, a clubbing configuration, an error configuration, and a retry count.

In accordance with an exemplary embodiment, the second set of data may correspond to an existing data that has been published to the target system.

In accordance with an exemplary embodiment, the variance data may correspond to a change between the first set of data and the second set of data.

In accordance with an exemplary embodiment, loading the variance data with the predefined label may correspond to assigning a status from among a changed status and a no changed status to the variance data, based on the comparison of the first set of data with the second set of data.

In accordance with an exemplary embodiment, the variance data is loaded in a record table format in the second repository with the predefined label.

In accordance with an exemplary embodiment, the loading of the first set of data and the configured metadata into the first repository is performed in parallel.

According to another aspect of the present disclosure, a computing device configured to publish a variance of data to a target system is disclosed. The computing device includes a processor; a memory; and a communication interface coupled to each of the processor and the memory. The processor may be configured to receive a first set of data, from a user. Next, the processor may be further configured to configure a metadata for the first set of data. Next, the processor may be configured to load the first set of data and the configured metadata in a first repository. Next, the processor may be further configured to retrieve a second set of data from a second repository. Next, the processor may be further configured to compare the first set of data with the second set of data to identify the variance data. Next, the processor may be further configured to load the variance data with a predefined label into the second repository. Next, the processor may be further configured to publish the variance data to the target system by utilizing the configured metadata.

In accordance with an exemplary embodiment, the first set of data may include at least from among a message function name and a detailed description of the message function name.

In accordance with an exemplary embodiment, the configured metadata may have been configured for the first set of data by using at least one from among a data source name, a data source uniform resource locator (URL), a data source structured query language (SQL) query, a data structure configuration, a data hierarchy relationship, a clubbing configuration, an error configuration, and a retry count.

In accordance with an exemplary embodiment, the second set of data may correspond to an existing data that has been published to the target system.

In accordance with an exemplary embodiment, the variance data may correspond to a change between the first set of data and the second set of data.

In accordance with an exemplary embodiment, the variance data loaded with the predefined label may correspond to assigning a status from among a changed status and a no changed status to the variance data, based on the comparison of the first set of data with the second set of data.

In accordance with an exemplary embodiment, the variance data may be loaded in a record table format in the second repository with the predefined label.

In accordance with an exemplary embodiment, the first set of data and the configured metadata may be loaded into the first repository in parallel.

According to yet another aspect of the present disclosure, a non-transitory computer-readable storage medium storing instructions for publishing a variance of data to a target system is disclosed. The instructions include executable code which, when executed by a processor, may cause the processor to receive a first set of data, from a user; configure a metadata for the first set of data; load the first set of data and the configured metadata into a first repository; retrieve a second set of data from a second repository; compare the first set of data with the second set of data to identify the variance data; load the variance data with a predefined label into the second repository; and publish the variance data to the target system by utilizing the configured metadata.

In accordance with an exemplary embodiment, the first set of data may include at least one from among a message function name and a detailed description of the message function name.

In accordance with an exemplary embodiment, the configured metadata may have been configured for the first set of data by using at least one from among a data source name, a data source uniform resource locator (URL), a data source structured query language (SQL) query, a data structure configuration, a data hierarchy relationship, a clubbing configuration, an error configuration, and a retry count.

In accordance with an exemplary embodiment, the second set of data may correspond to an existing data that has been published to the target system.

In accordance with an exemplary embodiment, the variance data may correspond to a change between the first set of data and the second set of data.

In accordance with an exemplary embodiment, the variance data loaded with the predefined label may correspond to assigning a status from among a changed status and a no changed status to the variance data, based on the comparison of the first set of data with the second set of data.

In accordance with an exemplary embodiment, the variance data may be loaded in a record table format in the second repository with the predefined label.

In accordance with an exemplary embodiment, the first set of data and the configured metadata may be loaded into the first repository in parallel.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for publishing a variance data to a target system, in accordance with an exemplary embodiment of the present disclosure.

FIG. 2 illustrates an exemplary diagram of a network environment for publishing a variance of data to a target system, in accordance with an exemplary embodiment of the present disclosure.

FIG. 3 illustrates a system diagram for publishing a variance data to a target system, in accordance with an exemplary embodiment of the present disclosure.

FIG. 4 illustrates an exemplary method flow diagram for publishing a variance data to a target system, in accordance with an exemplary embodiment of the present disclosure.

FIG. 5 illustrates an exemplary sequence flow diagram for metadata setup procedure, in accordance with an exemplary embodiment of the present disclosure.

FIG. 6 illustrates an exemplary sequence flow diagram for data load and publishing, in accordance with an exemplary embodiment of the present disclosure.

FIGS. 7A and 7B illustrates an exemplary process flow diagram for data loading, in accordance with an exemplary embodiment of the present disclosure.

FIG. 8 illustrates an exemplary process flow diagram for data publishing, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” may include any and all combinations and arrangements of one or more of the associated listed items. Also, as used herein, the phrase “at least one” means and may include “one or more” and such phrases or terms can be used interchangeably.

Unless otherwise defined, all terms (including technical and scientific terms) used herein have the same meaning as commonly understood by one of ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Furthermore, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for publishing a variance of data to a target system. Currently, a large number of processes need to be performed to implement any feature at the customer relationship management (CRM). Further, a development effort is required to consume a new application programming interface (API) or add a new data element or any update on an existing payload. This also increases time to market even for any small changes.

For instance, the following steps need to be performed to add a new data element:
Uniform Resource Identifier (URI) Document (if the target has parameterized Uniform Resource Locator (URLs))
URI Message (if the target has parameterized URLs)
Request Document (if power of sending transactions (POST), put update transaction (PUT), or partial application of changes to hypertext transfer protocol (HTTP) (PATCH))
Request Message (if POST, PUT, or PATCH)
Response Document
Response Message
Service
Service Operation
Service Operation Security
Handler code to trigger/process the messages.

Additionally, performing the below tasks using existing integration tools still requires the following sequence of processes:

### Use Case 1: Adding a New Data Element to an Existing Message

Add the data column on table (request design review board (DRB) approval)
Add the data element on document
Create new message version
Add the data element on the message
Update data source
Update the handler code
Update the error handling logic

### Use Case 2: Creating a New Integration

Create a table structure as per Javascript object notation (JSON) (request DRB approval)
Create document
Create message
Create service and service operation
Create routing
Create data source
Write handler code
Create Error handling logic

Moreover, the existing integration tools, such as PeopleSoft® delivered integration engine, do not provide an option to process the messages in parallel and/or add dependency of one message to another (parent-child relation).

To overcome the above-mentioned problems, the present disclosure provides an efficient solution that implements the framework to add any new feature and integration without involving a large sequence of steps or processes. In the present disclosure, at first, the system receives a first set of data, from a user. Next, the system configures a metadata for the received first set of data. Next, the system loads the first set of data and the configured metadata in a first repository. Next, the system retrieves a second set of data from a second repository. Next, the system compares the first set of data with the second set of data to identify the variance data. Next, the system loads the variance data with a predefined label into a second repository. Thereafter, the system publishes the variance data to a target system by utilizing the configured metadata.

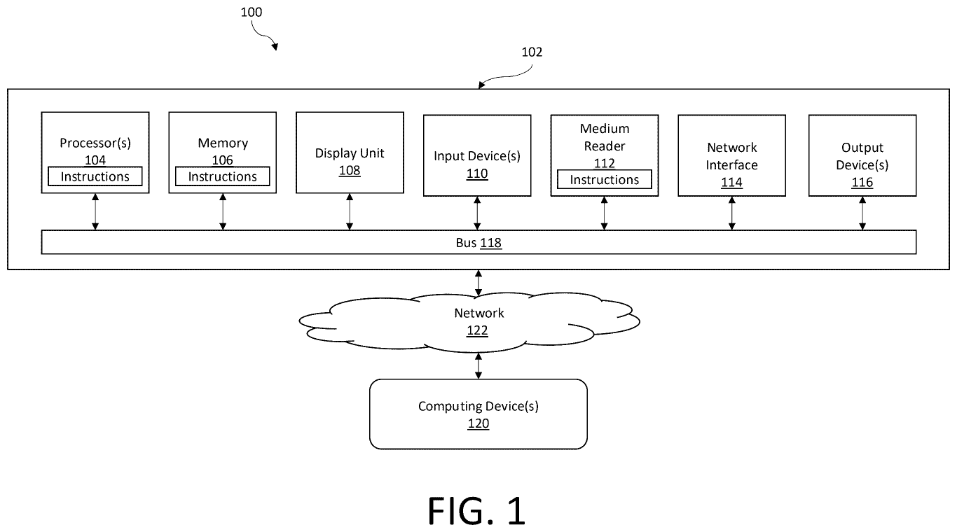

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that may include discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for publishing a variance of data to a target system.

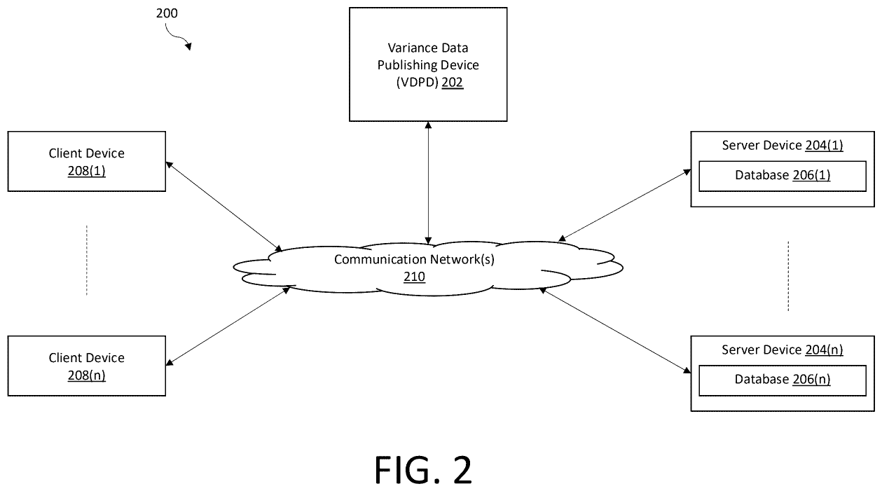

Referring to FIG. 2, a schematic of an exemplary network environment 200 for publishing a variance data to a target system is illustrated. In an exemplary implementation, the method is executable on any networked computer platform, such as, for example, a personal computer (PC).

The method for publishing the variance data to the target system may be executed by a variance data publishing device (VDPD) 202. The VDPD 202 may be the same or similar to the computer system 102 as described with respect to FIG. 1. The VDPD 202 may store one or more applications that may include executable instructions that, when executed by the VDPD 202, cause the VDPD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the VDPD 202 itself, may be located in the virtual server(s) running in a cloud-based computing environment rather than being tied to one or more specific physical network computing devices. Also, the application(s) may be running in one or more virtual machines (VMs) executing on the VDPD 202. Additionally, in one or more embodiments of this technology, virtual machine(s) running on the VDPD 202 may be managed or supervised by a hypervisor.

In the network environment 200 of FIG. 2, the VDPD 202 is coupled to a plurality of server devices 204(1)-204(n) that hosts a plurality of databases 206(1)-206(n), and also to a plurality of client devices 208(1)-208(n) via communication network(s) 210. A communication interface of the VDPD 202, such as the network interface 114 of the computer system 102 of FIG. 1, operatively couples and communicates between the VDPD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the VDPD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and VDPDs that efficiently implement the method for publishing the variance data to the target system.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, tele traffic in any suitable form (e.g., voice, modem, and the like), public switched telephone networks (PSTNs), ethernet-based packet data networks (PDNs), combinations thereof, and the like.

The VDPD 202 may be a standalone device or integrated with one or more other devices or apparatuses, such as one or more of the server devices 204(1)-204(n), for example. In one particular example, the VDPD 202 may include or be hosted by one of the server devices 204(1)-204(n), and other arrangements are also possible. Moreover, one or more of the devices of the VDPD 202 may be in a same or a different communication network including one or more public, private, or cloud-based networks, for example.

The plurality of server devices 204(1)-204(n) may be the same or similar to the computer system 102 or the computing device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the VDPD 202 via the communication network(s) 210 according to the hypertext transfer protocol (HTTP)-based and/or JavaScript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data associated with the customer relationship management (CRM) system.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the VDPD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, at one client device 208 is a wireless mobile communication device, e.g., a smartphone.

The client devices 208(1)-208(n) may run interface applications, such as standard web browsers or standalone client applications, which may provide an interface to communicate with the VDPD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the VDPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the VDPD 202, the server devices 204(1)-204(n), or the client devices 208(1)-208(n), for example, may be configured to operate as virtual instances on the same physical machine. In other words, one or more of the VDPD 202, the server devices 204(1)-204(n), or the client devices 208(1)-208(n) may operate on the same physical device rather than as separate devices communicating through communication network(s) 210. Additionally, there may be more or fewer VDPDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only tele traffic in any suitable form (e.g., voice and modem), wireless traffic networks, cellular traffic networks, packet data networks (PDNs), the Internet, intranets, and combinations thereof.

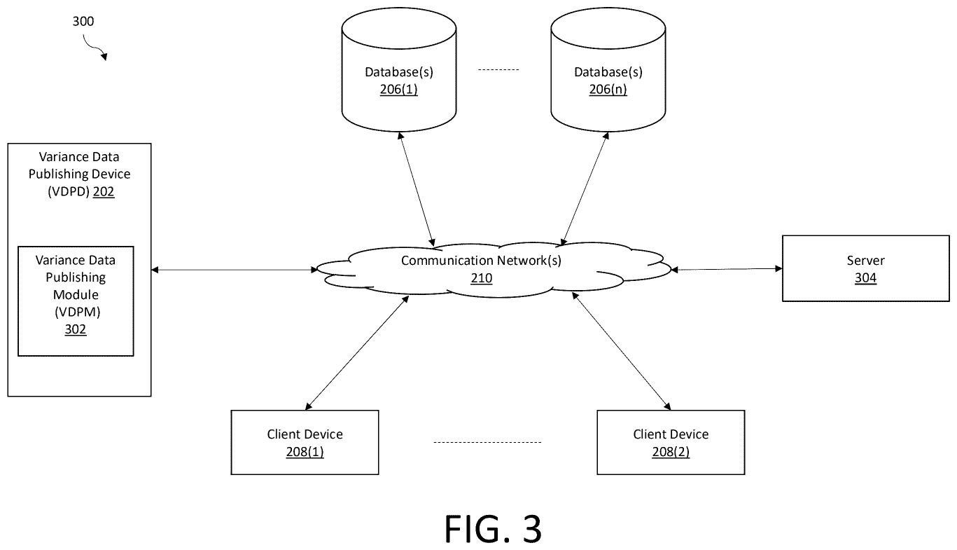

FIG. 3 illustrates a system diagram for publishing a variance data to a target system, in accordance with an exemplary embodiment.

As illustrated in FIG. 3, the system 300 may include a variance data publishing device (VDPD) 202 within which a variance data publishing module (VDPM) 302 is embedded, a server 304, a database(s) 206(1) . . . 206(n), a plurality of client devices 208(1) . . . 208(2), and a communication network(s) 210.

According to exemplary embodiments, the system 300 may comprise the variance data publishing device (VDPD) 202 including the VDPM 302 may be connected to the server 304 and the database(s) 206(1) . . . 206(n) via the communication network(s) 210, but the disclosure is not limited thereto. The VDPD 202 may also be connected to the plurality of client devices 208(1) . . . 208(2) via the communication network(s) 210, but the disclosure is not limited thereto. The database(s) 206(1) . . . 206(n) may include a rule database.

In an embodiment, the VDPD 202 is described and shown in FIG. 3 may include the VDPM 302, although it may include other rules, policies, modules, databases, or applications, for example. As will be described below, the VDPM 302 is configured to carry out a method for publishing the variance data to the target system.

An exemplary system 300 for enabling a mechanism for publishing the variance data to the target system by utilizing the network environment of FIG. 2 is shown as being executed in FIG. 3. Specifically, a first client device 208(1) and a second client device 208(2) are illustrated as being in communication with VDPD 202. In this regard, the first client device 208(1) and the second client device 208(2) may be “clients” of the VDPD 202 and are described herein as such. Nevertheless, it is to be known and understood that the first client device 208(1) and/or the second client device 208(2) need not necessarily be “clients” of the VDPD 202, or any entity described in association therewith herein. Any additional or alternative relationship may exist between either or both of the first client device 208(1) and the second client device 208(2) and the VDPD 202, or no relationship may exist.

Further, the VDPD 202 is illustrated as being able to access one or more database(s) 206(1) . . . 206(n). The VDPM 302 may be configured to access these repositories/databases to provide a method for publishing the variance data to the target system. In some embodiment, the server 304 may be the same or equivalent to the server device 204 as illustrated in FIG. 2

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the VDPD 202 via broadband or cellular communication. These embodiments are merely exemplary and are not limiting or exhaustive.

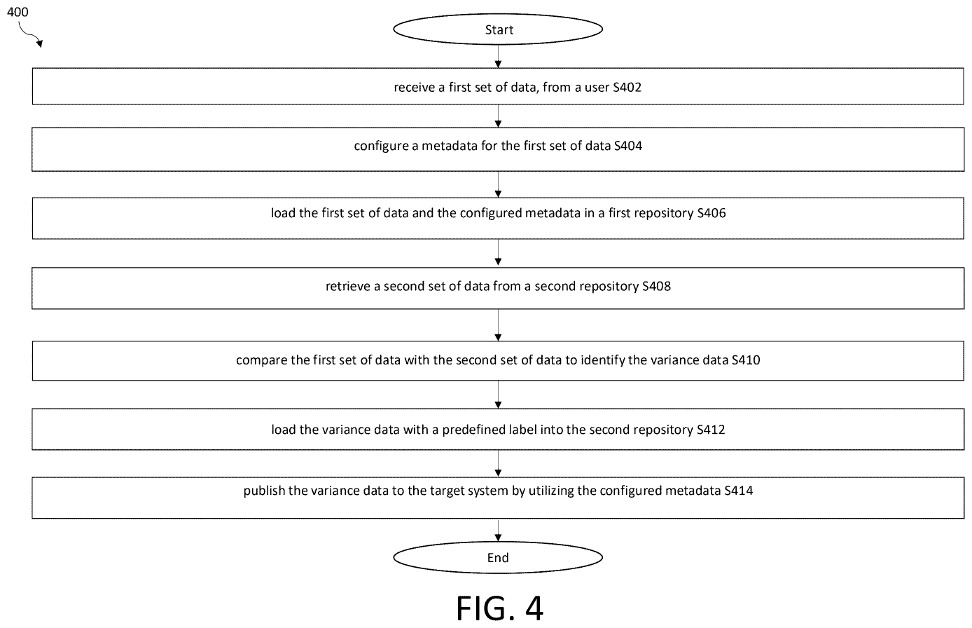

Referring to FIG. 4, an exemplary method 400 is shown for publishing a variance data to a target system, in accordance with an exemplary implementation. In particular, the exemplary method 400 is shown for publishing the variance data to the target system after eliminating the need to develop any code or perform complex tasks. As used herein, the variance data corresponds to changes made in the original data. In an example, the system may publish the completely updated data and/or changes made to the original data.

As shown in FIG. 4, method 400 begins following a need for publishing the variance data to the target system in a time-efficient manner. At step S402, the method 400 may include receiving, by the at least one processor 104, a first set of data, from a user. The first set of data may include at least a message function name and a detailed description of the message function. As used herein, the message function refers to a unique collection of metadata that is used for loading, comparing and publishing the data to the target system.

At step S404, the method may include configuring, by the at least one processor 104, a metadata for the received first set of data. The metadata is configured for the received first set of data using at least one from among a data source name, a data source uniform resource locator (URL), a data source structured query language (SQL) query, a data structure configuration, a data hierarchy relationship, a clubbing configuration, an error configuration, and a retry count. In an exemplary implementation, the metadata may be configured by the user (e.g., developer) and resides in a database. The metadata may include, but not limited to, the data source (e.g., SQL), a target URL, an alias name given to each attribute, a JSON tag name for the attribute, a data type, an order, a hierarchy required on the request or response payload, a default value, a retry count, error codes, dependencies, and a message club count.

At step S406, the method may include loading, by the at least one processor 104, the first set of data and the configured metadata in a first repository. The loading of the first set of data and the configured metadata in the first repository may be performed in at least one from among in parallel and in a sequence.

At step S408, the method may include retrieving, by the at least one processor 104, a second set of data from a second repository. The second set of data corresponds to data ('existing data') already published to the target system. In an exemplary implementation, the target system may be any downstream data consumer or a Kafka® topic that requires the system data. For publishing the data, the message function has a configuration for the service operation URL of the target system or the API endpoint that has been exposed by the target system for consumption.

At step S410, the method may include comparing, by the at least one processor 104, the first set of data with the second set of data to identify the variance data. The variance data corresponds to a change between the first set of data and the second set of data.

At step S412, the method may include loading, by the at least one processor 104, the variance data with a predefined label into the second repository. Loading the variance data with the predefined label may involve assigning a status of either “changed” or “no changed” to the variance data, based on the comparison between the first set of data and the second set of data. The variance data is loaded in a record table format in the second repository with the predefined label.

At step S414, the method may include publishing, by the at least one processor [104], the variance data to the target system by utilizing the configured metadata. The published variance data may be accessed by a customer on a computing device associated with the customer.

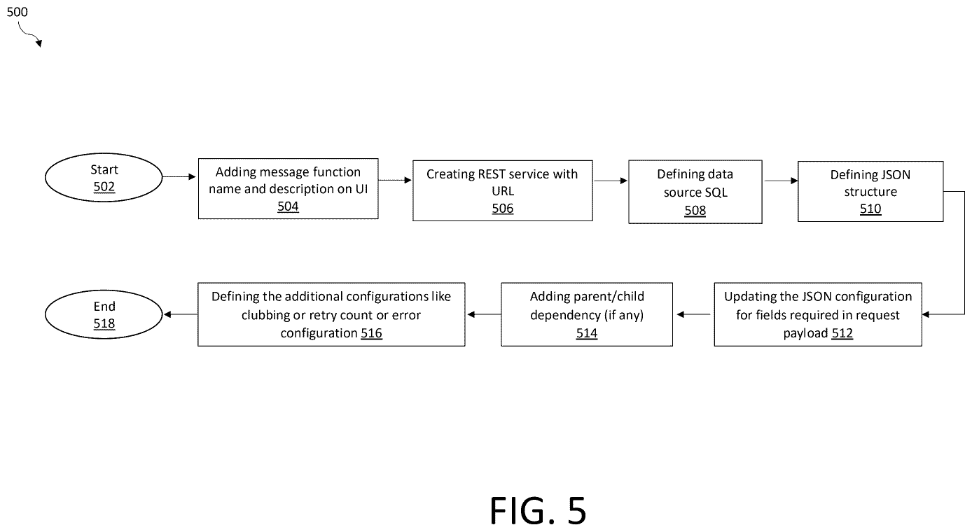

As shown in FIG. 5, sequence flow 500 illustrates metadata setup procedure, in accordance with an exemplary embodiment of the present disclosure. For the metadata setup, the user may configure a data source, service operation information, data processing information etc. The sequence flow 500 starts at step 502.

At step 504, the present disclosure may include adding a message function name and corresponding detail description on a user interface (UI). The user may provide input for adding the message function name and description of the message function via the user interface (UI) of any mobile device or computing device. The message function herein represents the configuration of metadata, which is required for processing or publishing any changes to dataset related to a unique entity. The configuration of metadata may be related to a data structure, a data format, and a data limit. As used herein, the unique entity refers to a combination of key attributes and/or non-key attributes that makes a dataset/record unique identifiable across the system. For example, employee identifier (ID) (e.g., unique entity) may be a combination of employee initials and their corresponding date of joining to represent the entire dataset of the employee. Further, in the description, the user may define service information, operations, and configuring inbound messages and outbound messages, actions (e.g., add, update, and delete), and routing paths.

Next, at step 506, the present disclosure may include creating a representational state transfer (REST) service with a uniform resource locator (URL). In an exemplary implementation, the user may create the REST service, via the UI, by defining operation and mapping with the URL. The user may define methods (e.g., GET, POST, DELETE) and routing rules.

Next, at step 508, the present disclosure may include defining a source of data (e.g., source structured query language (SQL)). The structured query language (SQL) that can be used as a source of data that needs to be evaluated (whether it is new or changed) by the process. The SQL represents the data source that the process uses to evaluate the new or changed data (entered or updated by the user).

Next, at step 510, the present disclosure may include defining a JavaScript object notation (JSON) structure. The user may define JSON structure for integrating and/or publishing the variance/updated/changed data within an internal system and/or with an external system. The user may define attributes such as, but not limited to, a definition, a structure type (e.g., fields, array, objects), a schema, and an operation type (e.g., inbound, and outbound) while defining the JSON structure.

Next, at step 512, the present disclosure may include updating a JSON configuration for fields required in a request payload. Further, the user may update the JSON configuration in JSON configuration file in existing fields, add new fields, remove fields, and update fields, structure, and definition as per the required requested JSON payload or data.

Next, at step 514, the present disclosure may include adding a parent/child dependency (if any). The user may define relationship or dependency for the payload data such as parent/child hierarchy. In an exemplary embodiment, based on the user-defined dependency, parent data may be processed and published first. After the successful processing of parent data, child data may be processed and published.

Next, at step 516, the present disclosure may include defining additional configurations like clubbing fields or objects, retrying count and/or error configuration. The user may define processing and sending configurations for the JSON data such as clubbing different fields and objects. Further, the user may define a retry count limit or threshold for resending and/or reprocessing any unsuccessful data transmission or operation. Furthermore, the user may define error handling configuration, such as including but not limited to, missing data handling, issuing error messages, and retry operations.

Thereafter, the sequence flow 500 terminates at step 518.

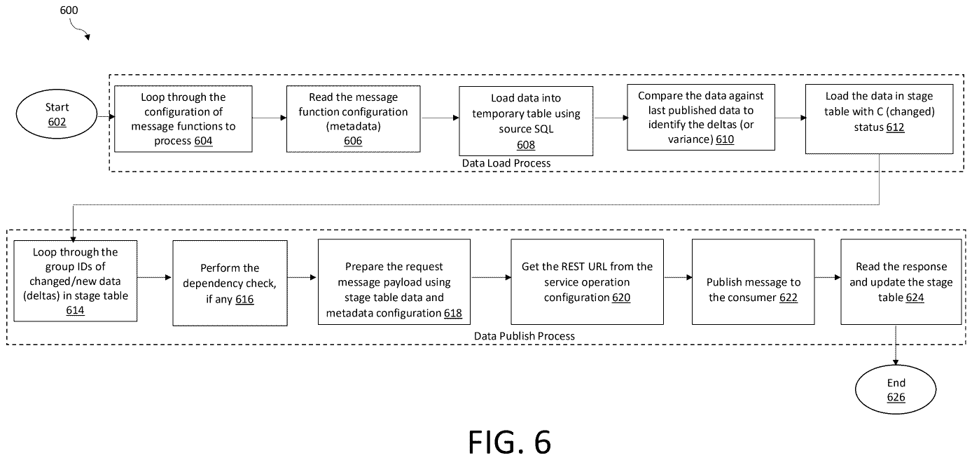

As shown in FIG. 6, sequence flow 600 illustrates a data load and publishing process, in accordance with an exemplary embodiment of the present disclosure. The sequence flow 600 consumes user-defined metadata configurations and service operations. The sequence flow 600 starts at step 602.

At step 604, sequence flow 600 as disclosed by the present embodiment may include looping through the configuration of message functions to process. The method 600 may include at least one service application engine. The service application engine is a set of structured query language (SQL) statements, and program control actions that may enable predefined/preconfigured looping and conditional logic of message functions or metadata to the processes. The at least one service application engine may perform such as, but not limited to, a batch process for processing of the message functions. The user may define a looping control logic implementation for a predefined number of counts for processing the message functions.

Next, at step 606, sequence flow 600 as disclosed by the present embodiment may include reading the message function configuration (metadata). The at least one service application engine (hereinafter interchangeably referred to as service application engine) may read or consume metadata configuration as defined by the user in the metadata setup procedure.

Next, at step 608, sequence flow 600 as disclosed by the present embodiment may include loading data into a temporary table using a source SQL. The service application engine may load data using the source SQL into the temporary table. The source SQL represents here as a source of data that needs to be evaluated whether it is new or changed by the process. The temporary table stores the data temporarily while processing only.

Next, at step 610, sequence flow 600 as disclosed by the present embodiment may comprise comparing the data against the last published data to identify the deltas or variance (such as new and updated data). Further, the service application engine may compare the data in the temporary table against the existing data in a stage table to identify the new and existing data that needs to be published. As used herein, the stage table may be used to store the copy of data last published as per the user's predefined configurations and preferences. In an exemplary implementation, the stage table may store compared datasets from the service application engine. The service application engine may compare the temporary table data and the stored stage table data to identify the delta (referred to as the data that has changed since the last processing) for any changes or updates.

Next, at step 612, sequence flow 600 as disclosed by the present embodiment may include loading the data in the stage table with C (changed) status. After comparing, the service application engine may load the published data in the staging table as marked ‘C’ for changed status. The changed status may correspond to any updates, additions, and deletions.

In an exemplary aspect, the steps from 604 to 612 of the sequence flow 600 are from the data load process.

Next, at step 614, sequence flow 600 as disclosed by the present embodiment may include a loop through the Group identifiers (IDs) of changed/new data in the stage table. After the data loading process, the same or another service application engine may perform the publishing process by looping the Group IDs of changed or new data in the stage table. The Group IDs used herein represent a unique combination of IDs that can be used to represent an entity. The service application engine may perform loop control logic for publishing any changed or new data status in the stage table as per user-defined configurations (e.g., number of attempts or number of reattempts).

Next, at step 616, sequence flow 600 as disclosed by the present embodiment performs the dependency check, if any. Further, the service application engine may perform relationship, or dependency checks for the payload data such as parent/child hierarchy. Based on the user-defined dependency check, parent data may be processed and published first. After the successful processing of parent data, child data may be processed and published.

Next, at step 618, sequence flow 600 as disclosed by the present embodiment may include preparing the request message payload using the stage table data and the metadata configuration. After performing the parent/child data dependency check, the service application engine may prepare a request message JSON payload using the stage table data and the metadata configuration. The service application engine may prepare for sending the request message payload or JSON payload based on the user's predefined metadata configurations and preferences for identified changes using the stage table.

Next, at step 620, sequence flow 600 as disclosed by the present embodiment may include getting the REST URL from the service operation configuration. Further, the service application engine may access the user's predefined service operation configuration and get the REST URL for the requested REST service.

Next, at step 622, sequence flow 600 as disclosed by the present embodiment may include a published message to the consumer. After getting the REST URL, the service application engine may publish a message associated with identified changes to the consumer or target system.

Next, at step 624, sequence flow 600 as disclosed by the present embodiment may include reading the response and updating the stage table. After receiving the published message, the target system processes the request and sends the appropriate response, that either the message has been successfully processed or there is any error. The target system sends the response back to the application engine. The service application engine may read the response and update the stage table accordingly. In an exemplary implementation, the service application engine may load the data in the stage table as marked ‘NC’ for no changed status, ‘NP’ for not processed status, and ‘RT’ for retry status.

In an exemplary aspect, the steps from 614 to 624 of the sequence flow 600 are from the data publishing process.

Thereafter, the sequence flow 600 terminates at step 626.

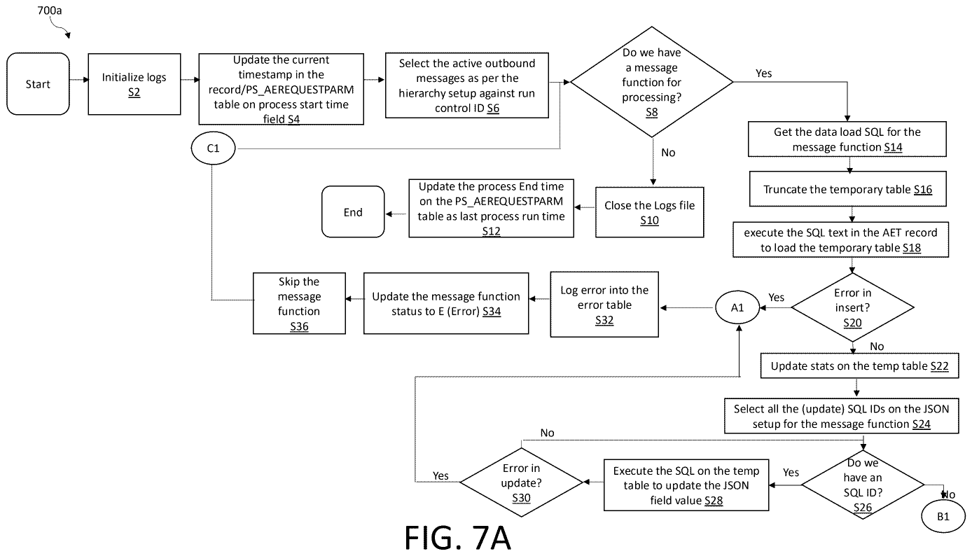

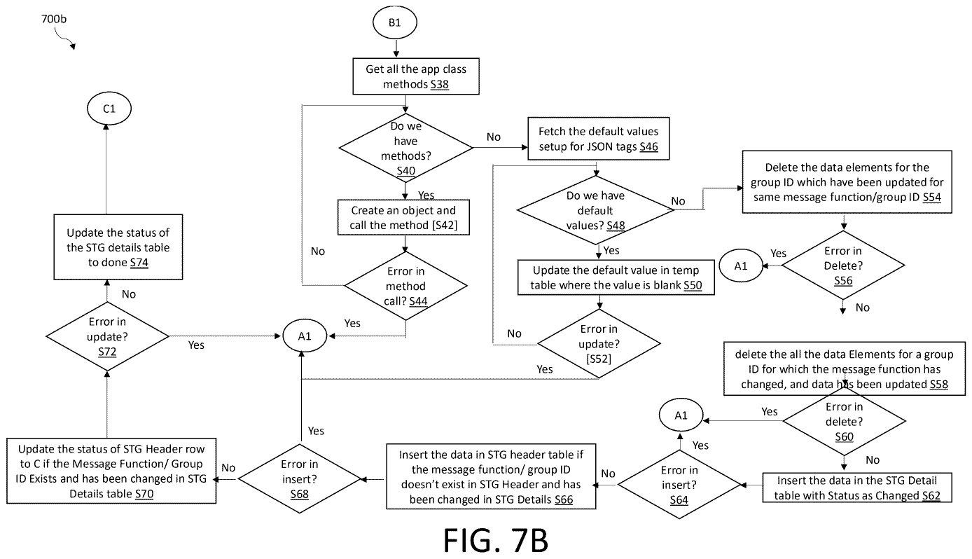

As shown in FIGS. 7A and 7B, process flow (700a and 700b) illustrates a data load process, in accordance with an exemplary embodiment of the present disclosure. The process flow (700a and 700b) initiates from the start step.

Next at S2, the process flow (700a and 700b) initializes logs.

Next at S4, the process flow (700a and 700b) updates the current timestamp in a record table on the process start time field. In an exemplary implementation, the record table is a PS_AEREQUESTPARM table.

Next at S6, the process flow (700a and 700b) selects the active outbound messages as per the hierarchy setup against run control identifier (ID).

Next at S8, the process flow (700a and 700b) checks an available message function for processing. If there is no message function for processing, the process flow (700a and 700b) closes the log file at S10. If there is a message function for processing, the process flow (700a and 700b) moves to S14 and gets the data load SQL for the message function. Further, after S10, the process flow (700a and 700b) updates the process end time on the record table (e.g., PS_AEREQUESTPARM table) as the last process run time at S12.

After the S14, the process flow (700a and 700b) truncates the temporary table at S16.

Next at S18, the process flow (700a and 700b) executes the SQL text in the AET Record to load the temporary table.

Next at S20, the process flow (700a and 700b) checks errors in insertion. If there is no error in insertion, the process flow (700a and 700b) updates stats on the temp table at S22 and if there is an error, the process flows (700a and 700b) logs error into the error table S32. After this, the process flows (700a and 700b) updates the message function status to E (Error) at S34 and further skips the message function at S36.

After the S22, the process flow (700a and 700b) selects all the (update) SQL IDs on the JSON setup for the message function at S24.

Next at S26, the process flow (700a and 700b) checks the availability of any SQL ID. If there is no SQL ID, the process flow (700a and 700b) gets all the App class methods at S38.

Next at S28, the process flow (700a and 700b) executes the SQL on the temp table to update the JSON field value.

Next at S30, the process flow (700a and 700b) checks for update errors. If there is no error, the process flow (700a and 700b) checks any SQL ID at S26. If there is an error, the process flow (700a and 700b) may log the error into the error table at S32.

After S38, the process flow (700a and 700b) checks available methods at S40. If there are methods, the process flow (700a and 700b) creates an object and calls the method step S42. The process flow further checks the error in the method call at step S44. If there is an error, the process flow (700a and 700b) logs the error into the error table at S32. Further, if there are no methods at S40, the process flow (700a and 700b) retrieves the default values setup for JSON tags at S46.

Next at S48, the process flow (700a and 700b) checks available default values. If there are default values, the process flow (700a and 700b) updates the default value in the temp table where the value is blank at S50 and further checks the error in updates at S52. If there is an error, the process flow (700a and 700b) logs the error into the error table at S32. Further, if there are no default values at S48, the process flow (700a and 700b) deletes the data elements for the Group ID which have been updated for the same message function/Group ID at S54.

Next at S56, the process flow (700a and 700b) checks errors in the delete process. If there is an error, the process flow (700a and 700b) logs the error into the error table at S32. If there is no error, the process flow (700a and 700b) deletes all the data elements for a Group ID for which the message function has changed, and data has been updated at S58.

Next at S60, the process flow (700a and 700b) checks errors in the delete process. If there is an error, the process flow (700a and 700b) logs the error into the error table at S32. If there is no error, the process flow (700a and 700b) inserts the data in the STG Detail table with the status as changed at S62.

Next at S64, the process flow (700a and 700b) checks errors in the insert process. If there is an error, the process flow (700a and 700b) logs the error into the error table at S32. If there is no error, the process flow (700a and 700b) inserts the data in the STG header table if the message function/Group ID does not exist in the STG header and has been changed in STG details at S66.

Next at S68, the process flow (700a and 700b) checks errors in the insert process. If there is an error, the process flow (700a and 700b) logs the error into the error table at S32. If there is no error, the process flow (700a and 700b) updates the status of the STG header row to C if the message function/Group ID exists and has been changed in the STG details table at S70.

Next at S72, the process flow (700a and 700b) checks errors in the update process. If there is an error, the process flow (700a and 700b) logs the error into the error table at S32. If there is no error, the process flow (700a and 700b) updates the status of the STG details table to done at S74.

The process flow (700a and 700b) terminates at the end step.

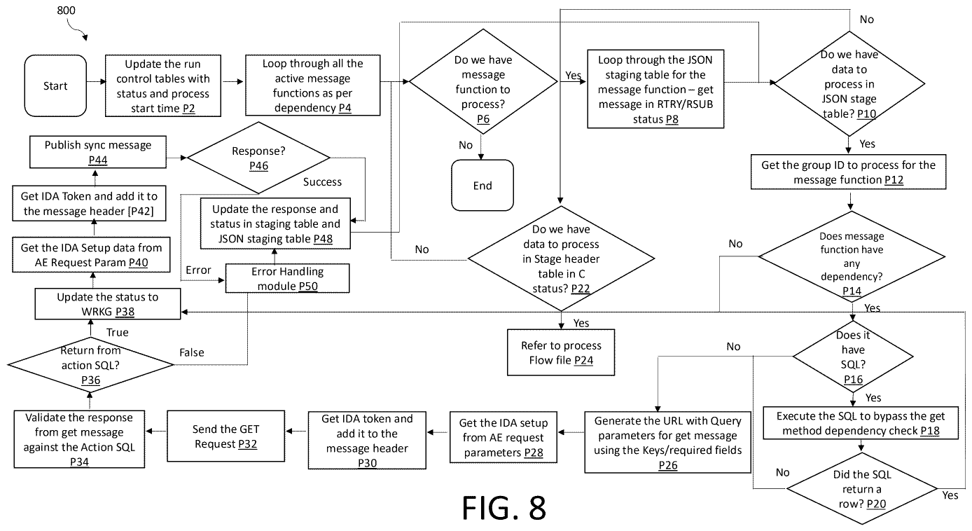

As shown in FIG. 8, process flow 800 illustrates the data publishing process, in accordance with an exemplary embodiment of the present disclosure. The process flow 800 initiates from the start step.

Next at P2, the process flow 800 may include updating the run control tables with status and process start time.

Next at P4, the process flow 800 may include looping through all the active message functions as per dependency (parent/child hierarchy).

Next at P6, the process flow 800 may include checking any available message function to process. If there is any message function, the process flow 800 may include looping through the JSON staging table for the message function-Get message in RTRY/RSUB status at P8.

Next at P10, the process flow 800 may include checking any data to process in the JSON Stage table at P10. If there is no data, the process flow 800 may include checking any available data to process in the stage header table in C status at P22. If there is data to process in the stage header table, the process flow 800 may include referring to the process flow file at P24. If there is no data to process in the stage header table, the process flow 800 may include returning to P10. Further, at P10, if there is data to process in the JSON stage table, the process flow 800 may include getting the Group ID to process for the message function at P12.

Next at P14, the process flow 800 may include checking any dependency in the message function. If there is any dependency at P14, the process flow 800 may include checking any available SQL at P16. If there is no dependency at P14, the process flow 800 may include updating the status to WRKG at P38.

Next at P16, if there is any SQL, the process flow 800 may include executing the SQL to bypass the Get method dependency check at P18 otherwise the process flow moves to P26. Next, the process flow 800 may include checking that any SQL returned a row at P20. If the process flow 800 may include determined positive then, the process flow 800 may include updating the status to WRKG at P38. If the process flow 800 may include determining negative then, the process flow moves to P26.

At P26, the process flow 800 may include generating the URL with query parameters for Get message using the Keys/Required fields.

Next at P28, the process flow 800 may include getting the IDA setup from AE request parameters.

Next at P30, the process flow 800 may include getting the IDA setup from AE request parameters.

Next, at P32, the process flow 800 may include sending the GET request.

Next at P34, the process flow 800 may include validating the response from the Get message against the Action SQL.

Next at P36, the process flow 800 may include checks returning from Action SQL. If any return from Action SQL is true, the process flow 800 may include updates the status to WRKG at P38. If any return from Action SQL is false, the process flow 800 may include goes to the error handling module at P50.

After P38, the process flow 800 may include getting the IDA setup data from AE Request Param at P40.

Next at P42, the process flow 800 may include getting an IDA token and adding it to the message header.

Next at P44, the process flow 800 may include publishing a sync message.

Next at P46, the process flow 800 may include checking responses. If the response is successful, the process flow 800 may include updating the response and status in the staging table and JSON staging table at P48. After P48, the process flow moving to P10. If the response has an error, the process flow 800 may include going to the error handling module at P50.

The process flow 800 terminates at the end step.

The present disclosure provides numerous advantages as given below. The present disclosure allows developers or users to add new features or elements to the platform or customer relationship management (CRM) system without writing any code. The present disclosure allows the developers or users to implement or integrate any feature in a parallel manner. The present disclosure provides a solution to check the parent-child dataset relationship and proceed with child dataset for publishing after successfully processing and publishing the parent dataset.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” may include a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to yet another aspect of the present disclosure, a non-transitory computer-readable storage medium storing instructions for publishing a variance of data to a target system is disclosed. The instructions include executable code which, when executed by a processor, may cause the processor to receive a first set of data, from a user; configure a metadata for the received first set of data; load the first set of data and the configured metadata in a first repository; retrieve a second set of data from a second repository; compare the first set of data with the second set of data to identify the variance data; load the variance data with a predefined label into the second repository; and publish the variance data to the target system by utilizing the configured metadata.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A method for publishing a variance data to a target system, the method being implemented by at least one processor, the method comprising:
receiving, by the at least one processor, a first set of data, from a user;
configuring, by the at least one processor, a metadata by defining a set of fields that are required for the first set of data;
loading, by the at least one processor, the first set of data and the configured metadata into a first repository;
retrieving, by the at least one processor, a second set of data from a second repository;
loading, by the at least one processor, the variance data with a predefined label into the second repository, wherein the variance data comprises a set of differences between the first set of data and the second set of data;
utilizing, by the at least one processor, the configured metadata to determine the set of fields that are required to publish the variance data; and
executing loop control logic to publish, by the at least one processor, the variance data to the target system according to the configured metadata.

2. The method as claimed in claim 1, wherein the first set of data comprises at least one from among a message function name and a detailed description of the message function name.

3. The method as claimed in claim 1, wherein the configured metadata has been configured for the first set of data by using at least one from among a data source name, a data source uniform resource locator (URL), a data source structured query language (SQL) query, a data structure configuration, a data hierarchy relationship, a clubbing configuration, an error configuration, and a retry count.

4. The method as claimed in claim 1, wherein the second set of data corresponds to an existing data that has been published to the target system.

5. The method as claimed in claim 1, wherein the variance data corresponds to a change between the first set of data and the second set of data.

6. The method as claimed in claim 1, wherein loading the variance data with the predefined label corresponds to assigning a status from among a changed status and a no changed status to the variance data, based on the comparison of the first set of data with the second set of data.

7. The method as claimed in claim 1, wherein the variance data is loaded in a record table format in the second repository with the predefined label.

8. The method as claimed in claim 1, wherein the loading of the first set of data and the configured metadata into the first repository is performed in parallel.

9. A computing device configured to publish a variance data to a target system, the computing device comprising:
a processor;
a memory; and
a communication interface coupled to the processor and the memory, wherein the processor is configured to:
receive a first set of data, from a user;
configure a metadata by defining a set of fields that are required for the first set of data;
load the first set of data and the configured metadata in a first repository;
retrieve a second set of data from a second repository;
load the variance data with a predefined label into the second repository, wherein the variance data comprises a set of differences between the first set of data and the second set of data;
utilize the configured metadata to determine the set of fields that are required to publish the variance data; and
execute loop control logic to publish the variance data to the target system according to the configured metadata.

10. The computing device as claimed in claim 9, wherein the first set of data comprises at least one from among a message function name and a detailed description of the message function name.

11. The computing device as claimed in claim 9, wherein the configured metadata has been configured for the first set of data by using at least from among a data source name, a data source uniform resource locator (URL), a data source structured query language (SQL) query, a data structure configuration, a data hierarchy relationship, a clubbing configuration, an error configuration, and a retry count.

12. The computing device as claimed in claim 9, wherein the second set of data corresponds to an existing data that has been published to the target system.

13. The computing device as claimed in claim 9, wherein the variance data corresponds to a change between the first set of data and the second set of data.

14. The computing device as claimed in claim 9, wherein the variance data loaded with the predefined label corresponds to assigning a status from among a changed status and a no changed status to the variance data, based on the comparison of the first set of data with the second set of data.

15. The computing device as claimed in claim 9, wherein the variance data is loaded in a record table format in the second repository with the predefined label.

16. The computing device as claimed in claim 9, wherein the first set of data and the configured metadata are loaded into the first repository in parallel.

17. A non-transitory computer readable storage medium storing instruction for publishing a variance data to a target system, the storage medium comprising executable code which, when executed by a processor, causes the processor to:
receive a first set of data, from a user;
configure a metadata by defining a set of fields that are required for the first set of data;
load the first set of data and the configured metadata into a first repository;
retrieve a second set of data from a second repository;
load the variance data with a predefined label into the second repository, wherein the variance data comprises a set of differences between the first set of data and the second set of data;
utilize the configured metadata to determine the set of fields that are required to publish the variance data; and
execute loop control logic to publish the variance data to the target system by utilizing according to the configured metadata.

18. The storage medium as claimed in claim 17, wherein the first set of data comprises at least one from among a message function name and a detailed description of the message function name.

19. The storage medium as claimed in claim 17, wherein the configured metadata has been configured for the first set of data by using at least one from among a data source name, a data source uniform resource locator (URL), a data source structured query language (SQL) query, a data structure configuration, a data hierarchy relationship, a clubbing configuration, an error configuration, and a retry count.

20. The storage medium as claimed in claim 17, wherein the second set of data corresponds to an existing data that has been published to the target system.
